(19) United States
(12) Patent Application Publication
(10) Pub. No.: US 2019/0160798 A1
(43) Pub. Date: May 30, 2019

(54) REPLACING DEVICE FOR LAMINATED MANUFACTURING PLATFORM

(71) Applicant: National Chung-Shan Institute of Science and Technology, Taoyuan City (TW)

(72) Inventors: Kuo-kuang JEN, Taoyuan City (TW); Chung-chun HUANG, Taoyuan City (TW); Che-chang CHENG, Taoyuan City (TW); Tzu-chia YANG, KAOHSIUNG CITY (TW); Chi-hsiang HUNG, KAOHSIUNG CITY (TW); Hsin-pao CHEN, KAOHSIUNG CITY (TW); Jui-hsiung YEN, KAOHSIUNG CITY (TW)

(21) Appl. No.: 15/898,588

(22) Filed: Feb. 18, 2018

(30) Foreign Application Priority Data
Nov. 24, 2017 (TW) 106140905

(51) Int. Cl. B32B 37/00

(52) U.S. Cl. CPC B32B 37/0046; B29C 64/245

(57) ABSTRACT

A replacing device for a laminated manufacturing platform is provided. The replacing device has a box, a carrying body, and a lifting mechanism. The box includes two slides. The carrying body can slide on the slide and be replaced by another carrying body. Thus, problems that a working platform of a laminated manufacturing equipment is not moved, workpieces are not automatically produced and the workpieces are not synchronously replaced can be effectively solved.

### FIELD OF INVENTION

The present invention relates to a replacing device for a platform, and in particular to a replacing device for a laminated manufacturing platform.

### BACKGROUND OF INVENTION

Currently, large platforms for laminated manufacturing equipment adopt a fixed manner to form laminate power layers of a workpiece. Specifically, a laminated manufacturing equipment includes a printing platform support, a printing platform, a heating module, an adjusting module, and a printing plate, wherein the printing platform is disposed on the printing platform support, the heating module is disposed on the printing platform, and the adjusting module is disposed on the printing platform and includes a plurality of the locking units. The printing plate has a working surface and a disposing surface. The disposing surface contact with the heating module, and the printing plate is removable and disposed on the printing platform, and the printing plate can be locked and unlocked by the locking units.

However, the printing platform adopts a fixed manner to reduce the manufacturing flexibility, and locking action and unlocking action are processed frequently so that automated production is not easy to be achieved. For small workpieces or assembling workpieces, it takes more time to repeat the manufacturing and set the time, and the workpieces cannot be processed at the same time. In addition, when replacing workpieces, it needs to rely on manual processing or to use conveyor belts.

As a result, it is necessary to provide an improved replacing device for a laminated manufacturing platform to solve the problems existing in the conventional technologies, as described above.

### SUMMARY OF INVENTION

A workpiece of the present invention is to provide a replacing device for a laminated manufacturing platform, wherein a carrying body can move along slide rails to replace another carrying body so that the problems that a working platform of a laminated manufacturing equipment is not moved and workpieces are not automatically produced and synchronously replaced can be effectively solved.

To achieve the above workpieces, the present invention provides a replacing device for a laminated manufacturing platform. The replacing device comprises a box, a carrying body, and at least one lifting mechanism. The box includes a bottom wall, a through hole formed in the bottom wall, two sidewalls extended from two opposite sides of the bottom wall, respectively, and two slide rails disposed on the two sidewalls of the box, respectively. The carrying body includes a base located between the two slide rails and formed with an opening, a plurality of sliding components disposed on two opposite sides of the base and configured to slide on the slide rails, a hollow frame disposed on the base, wherein the hollow frame includes a movement space, and a top end of the hollow frame defines a processing position, and a working platform movably disposed on the base and located within the movement space. The lifting mechanism disposed under the box and includes a lifting base, a driving rod disposed on the lifting base, and a lifting platform disposed on the driving rod and configured to pass the opening into the movement space and be driven by the driving rod so as to push the working platform to move up and down between the base and the processing position.

In one embodiment of the present invention, a plurality of the bases are formed with a plurality of the openings separated from each other, the box includes a plurality of the through holes separated from each other, the replacing device comprises a plurality of the lifting mechanisms, and each of the lifting platforms of the lifting mechanisms correspondingly passes one of the through holes and one of the openings, respectively.

In one embodiment of the present invention, the replacing device further comprises a plurality of energy emitting devices disposed on the box, and each of the energy emitting devices corresponds to one of the lifting platforms.

In one embodiment of the present invention, the box further comprises a positioning block disposed at a side of the slide rails and configured to contact the base and stop the base moving.

In one embodiment of the present invention, the replacing device further comprises an energy emitting device disposed above the lifting platform and configured to laminate power layers of a workpiece on the working platform.

In one embodiment of the present invention, the replacing device further comprises a locking device disposed on the base and configured to fix the base.

In one embodiment of the present invention, the hollow frame is disposed at a peripheral edge of an upper surface of the base.

In one embodiment of the present invention, the hollow frame is made of a metal.

In one embodiment of the present invention, a diameter of the lifting platform is equal to an inner diameter of the opening.

In one embodiment of the present invention, the sliding components are rolling wheels.

As described above, during the laminating process, the working platform is move down as laminated power layers of the workpiece. When the workpiece is completed, the carrying body is slid along the slide rails and moved out from the box, and another carrying body is moved into the box so that the problem that a laminated manufacturing platform cannot be flexibly used in the laminating process and cannot automatically replace the workpiece so that automated production, increasing process flexibility of products, semi-finished products, and assembling products, and reducing costs can be achieved. Therefore, it can solve the problems that a working platform of a laminated manufacturing equipment is not moved and workpieces are not automatically produced and synchronously replaced can be effectively.

### DESCRIPTION OF DRAWINGS

FIG. 1 is a schematic view of a replacing device for a laminated manufacturing platform according to a preferred embodiment of the present invention.

FIG. 2 is a sectional view of the replacing device for the laminated manufacturing platform before a base of a carrying body is pushed according to the preferred embodiment of the present invention.

FIG. 3 is a sectional view of the replacing device for the laminated manufacturing platform after the base of the carrying body is pushed according to the preferred embodiment of the present invention.

FIGS. 4 to 8 are schematic views of the carrying body the replacing device for the laminated manufacturing platform adopted a variety of sizes according to the preferred embodiment of the present invention.

### DETAILED DESCRIPTION OF PREFERRED EMBODIMENTS

The structure and the technical means adopted by the present invention to achieve the above and other workpieces can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

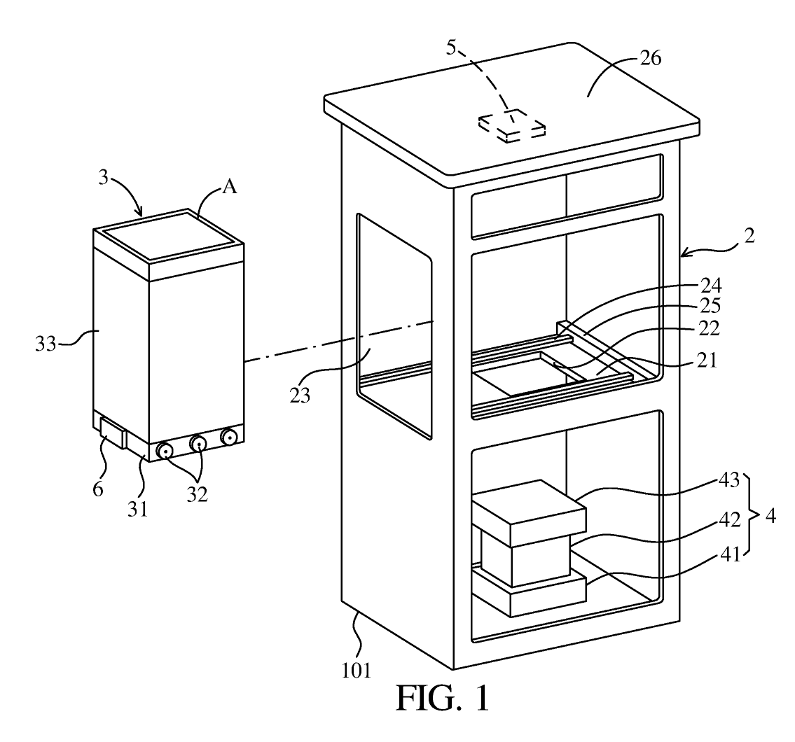

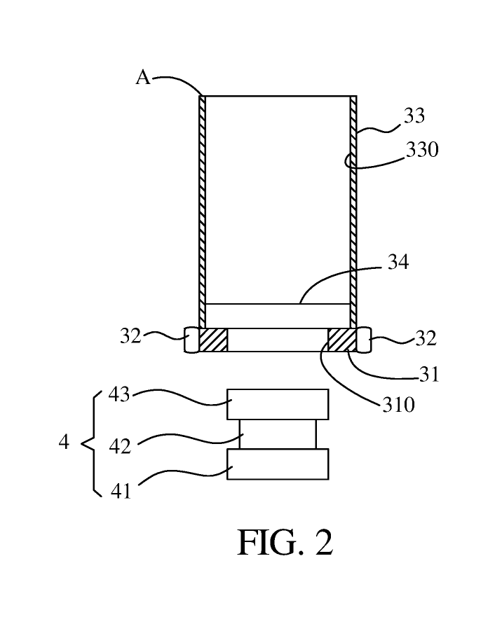

Referring to FIGS. 1-3, a replacing device for a laminated manufacturing platform according to a preferred embodiment of the present invention is provided, wherein the replacing device comprises a bottom case 101, a box 2, a carrying body 3, at least one lifting mechanism 4, at least one energy emitting device 5, and a locking device 6. The detailed structure of each component, assembly relationships, and principle of operation in the present invention will be described in detail hereinafter.

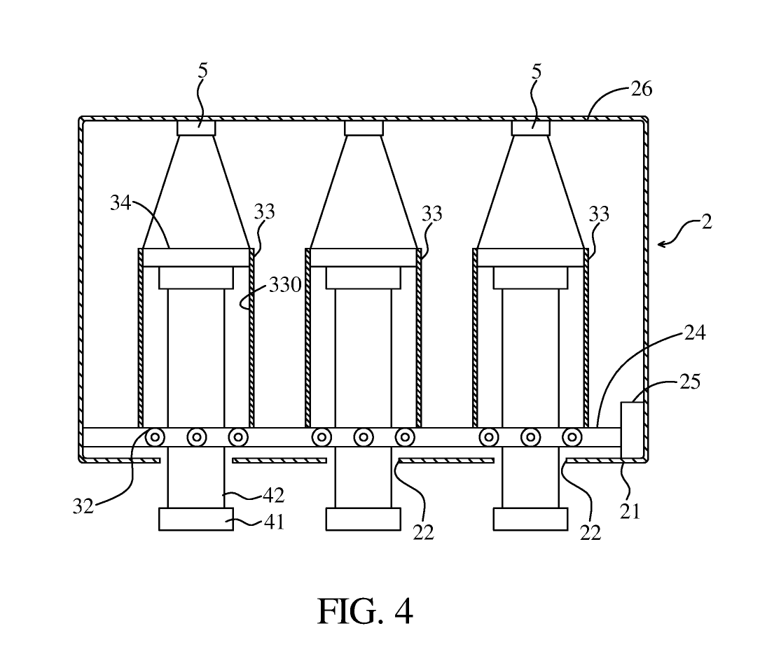

Referring to FIGS. 1-3, the box 2 is disposed on the bottom case 101, and the box 2 includes a bottom wall 21, at least one through hole 22, two sidewalls 23, two slide rails, and a positioning block 25, wherein the through hole 22 is formed in the bottom wall 21, the two sidewalls 23 are extended from two opposite sides of the bottom wall 21, respectively, the two slide rails 24 are disposed on the two sidewalls 23 of the box 2, respectively, and the positioning block 25 is disposed at a side of the slide rails 24. In the embodiment, the bottom wall 21 can form with one through hole 22 as shown in FIG. 1, and also form with three through hole 22 as shown in FIG. 4, it is not limited thereto.

Referring to FIGS. 1-3, the carrying body 3 includes a base 31, a plurality of sliding components 32, a hollow frame 33, and a working platform 34, wherein the base 31 is located between the two slide rails 24 and the base 31 is formed with an opening 310, the two sliding components 32 is disposed on two opposite sides of the base 31 and configured to slide on the slide rails 24, the hollow frame 33 is disposed on the base 31, wherein the hollow frame 33 includes a movement space 330, a top end of the hollow frame 33 defines a processing position A, the working platform 34 is movably disposed on the base 31 and located within the movement space 330. In the embodiment, the hollow frame 33 is disposed at a peripheral edge of an upper surface of the base 31, and the hollow frame 33 is made of a metal. In addition, the sliding components 32 are rolling wheels and configured to slide on the slide rails 24 to drive the base 31 moving.

Referring to FIGS. 1-3, the lifting mechanism 4 is disposed under the box 2 and located within the bottom case 101. The lifting mechanism 4 includes a lifting base 41, a driving rod 42, and a lifting platform 43, wherein the driving rod is disposed on the lifting base 41, and the lifting platform 43 is disposed on the driving rod 42 and configured to pass the opening 310 into the movement space 330 and be driven by the driving rod 42 passing the through hole 22 and the opening 310 (as shown FIG. 4) so as to push the working platform 34 to move up and down between the base 31 and the processing position A. In the embodiment, a diameter of the lifting platform 43 is equal to an inner diameter of the opening 310.

Referring to FIG. 4, the box 2 can also be accommodated a plurality of the hollow frames 33 and disposed a plurality of the energy emitting devices 5. A plurality of the bases 31 are formed with a plurality of the openings 310 separated from each other, and the box 2 has a plurality of the through hole 22 separated from each other. The replacing device comprises a plurality of the lifting mechanisms, and each of the lifting platforms of the lifting mechanisms 4 correspondingly passes one of the through holes 22 and one of the openings 310, respectively. In the embodiment, the energy emitting devices 5 are a plurality of the laser emitter.

Referring to FIGS. 4 to 8, the energy emitting devices 5 are disposed on a top wall 26 of the box 2 and separated from each other, wherein each of the energy emitting devices 5 corresponds to one of the lifting platforms 43 and the energy emitting devices 5 are located above the working platform 34 and configured to laminate power layers of a workpiece on the working platform 34. In addition, the locking device 6 is disposed on the base 31, and the locking device 6 is configured to fix the base 31 when the base 31 moves to a predetermined position.

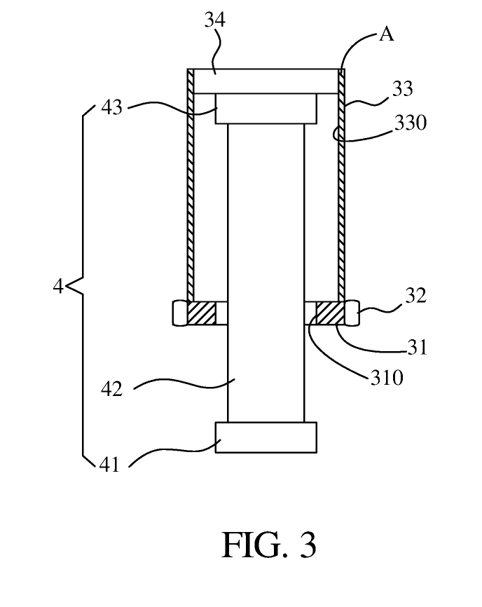

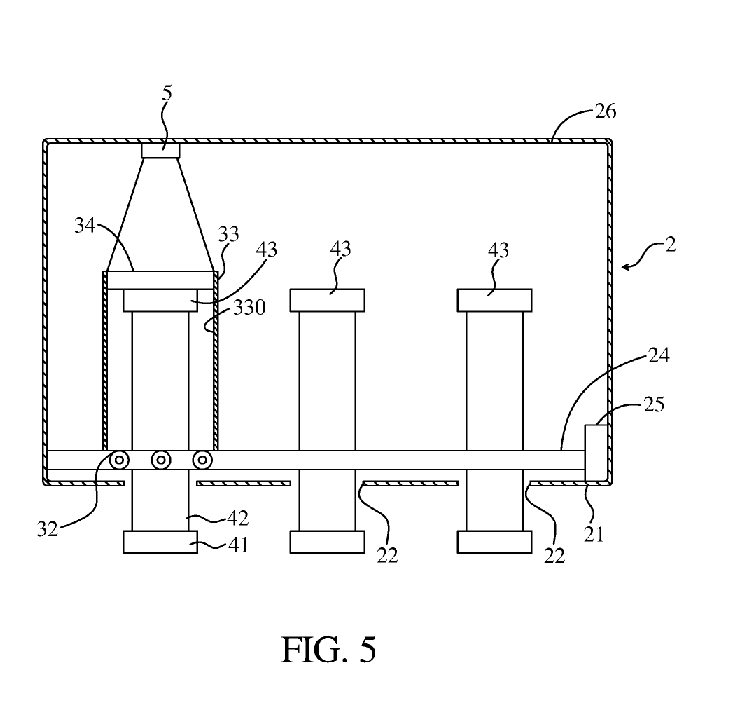

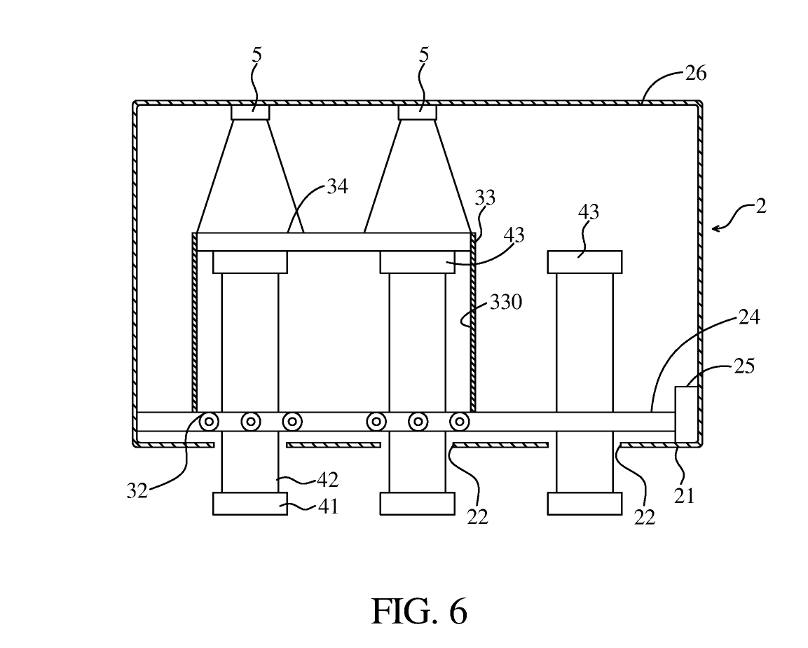

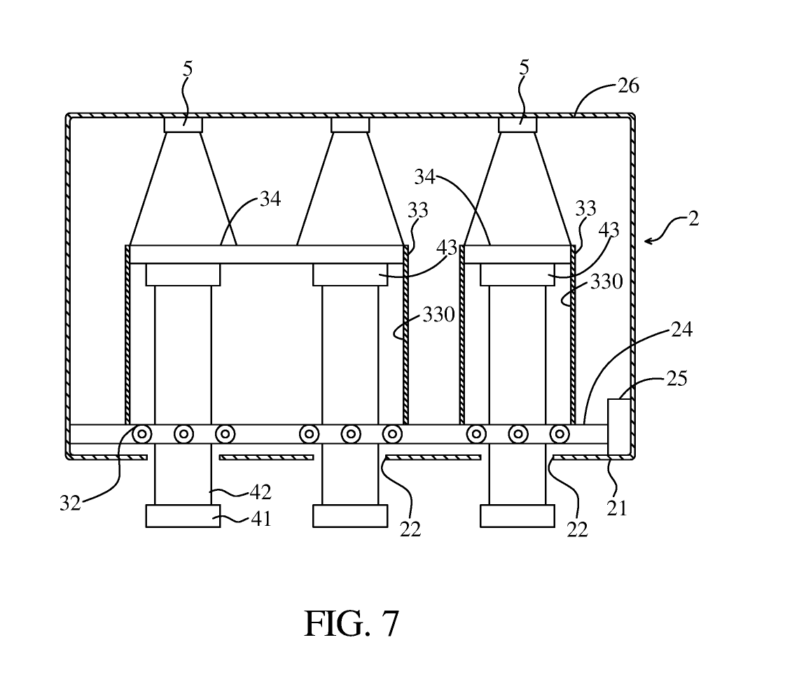

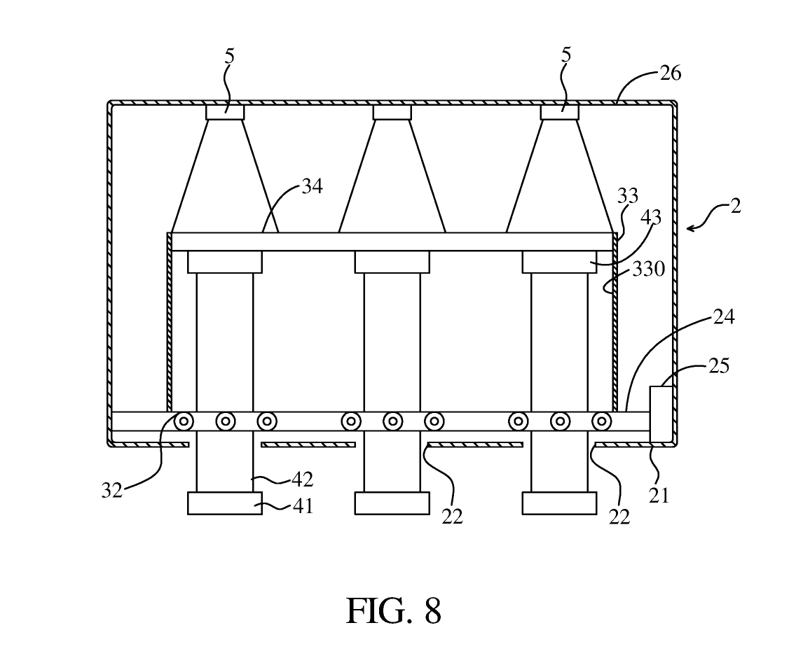

Referring to FIGS. 3, 6 and 8, the bases 31 forms the openings 310 separated from each other, and the box 2 forms three through holes 22 and configured to be passed three lifting platforms 43 of the lifting mechanism 4. In addition, the hollow frame 33 of the carrying body 3 can depends processing needs to choose an only small size, such as 400×400×400 mm, laminated power layers of a workpiece (as shown in FIG. 4 and FIG. 5), or to choose a medium size, such as 800×400×400 mm, laminated power layers of a workpiece (as shown in FIG. 6), or to choose a large size, such as 1200×400×400 mm, laminated power layers of a workpiece (as shown in FIG. 8), or choose two size at the same time, such as 400×400×400 mm and 800×400×400 mm, laminated power layers of a single workpiece or an assembling workpiece (as shown in FIG. 7).

According to the described structure, when the sliding components 32 of the carrying body 3 slide into the box 2 along the slide rails 24 of the box 2, the carrying body 3 will contact with the positioning block 25 and stop moving. The positioning block 25 make the opening 310 of the carrying body 3 aimed at the lifting platforms 43 of the lifting mechanism 4, and the problem that the carrying body 3 slide into the box 2 and need to adjust the position can be solved. After the carrying body 3 is positioned, a rear side of the base 31 of the carrying body 3 is disposed the locking device 6, and the locking device 6 can fix the carrying body 3 on the bottom wall 21. After the carrying body 3 is fixed, the lifting platform 43 is moved up, and passed through the through hole 22 and the opening 310 of the carrying body 3 to contact with the working platform 34. The working platform 34 is pushed up to the processing position A. The energy emitting devices 5 are located above the processing position A and emit lasers to laminated power layers of a workpiece on the working platform 34. The workpiece is gradually formed, and the working platform 34 is moved down until the workpiece is completed. The working platform 34 is moved with the lifting platforms 43 down into the movement space 330 until the working platform 34 contact with the base 31, and the working platform 34 places on the base 31. The lifting platforms 43 is still moved down and passed through the opening 310 and through hole 22 to leave the carrying body 3, and the lifting platforms 43 stops moving until the lifting platforms 43 is close the lifting base 41 so that a lifting movement of the lifting platforms 43 configured to laminate power layers is completed.

A main machine (not shown) controls the box 2 to replace workpiece and replace the working platform 34. Firstly, the locking device 6 disposed on the base 31 of the carrying body 3 is unlocked, and the workpiece placed on the working platform 34 is carried through the carrying body 3 sliding along the slide rails 24 of the box 2 to move out from the box 2, and a new carrying body 3 is move into the box 2 to process next laminate power layers of workpiece. Therefore, a replacing movement of the working platform 34 configured to laminate power layers is completed.

As described above, during the laminating process, the working platform 34 is move down as laminated power layers of the workpiece. When the workpiece is completed, the carrying body 3 is slid along the slide rails 24 and moved out from the box 2, and another carrying body 3 is moved into the box 2 so that the problem that a laminated manufacturing platform cannot be flexibly used in the laminating process and cannot automatically replace the workpiece so that automated production, increasing process flexibility of products, semi-finished products, and assembling products, and reducing costs can be achieved. Therefore, it can solve the problems that a working platform of a laminated manufacturing equipment is not moved and workpieces are not automatically produced and synchronously replaced can be effectively.

The present invention has been described with preferred embodiments thereof and it is understood that many changes and modifications to the described embodiments can be carried out without departing from the scope and the spirit of the invention that is intended to be limited only by the appended claims.

1. A replacing device for a laminated manufacturing platform, comprising:
a box including:
a bottom wall;
a through hole formed in the bottom wall;
two sidewalls extended from two opposite sides of the bottom wall, respectively;
two slide rails disposed on the two sidewalls of the box, respectively; and
a positioning block disposed at an end of the slide rails;
a carrying body configured to slide into the box and including:
a base located between the two slide rails and formed with an opening;
a plurality of sliding components disposed on two opposite sides of the base and configured to slide on the slide rails, wherein the sliding components are configured to slide into the box along the slide rails of the box, and the positioning block configured to contact the base and stop the base from moving;
a hollow frame disposed on the base, wherein the hollow frame includes a movement space, and a top end of the hollow frame defines a processing position; and
a working platform movably disposed on the base and located within the movement space; and
at least one lifting mechanism disposed under the box and including:
a lifting base;
a driving rod disposed on the lifting base; and
a lifting platform disposed on the driving rod and configured to pass the opening into the movement space and be driven by the driving rod so as to push the working platform to move up and down between the base located between the two slide rails and the processing position.

2. The replacing device for the laminated manufacturing platform according to claim 1, wherein the carrying body comprises a plurality of bases each having a corresponding opening separated from the other openings, the box includes a plurality of through holes separated from each other, the replacing device comprises a plurality of lifting mechanisms, and each of the lifting platforms of the lifting mechanisms correspondingly passes one of the through holes and one of the openings, respectively.

3. The replacing device for the laminated manufacturing platform according to claim 2, wherein the replacing device further comprises a plurality of energy emitting devices disposed on the box, and each of the energy emitting devices corresponds to one of the lifting platforms.

4. (canceled)

5. The replacing device for the laminated manufacturing platform according to claim 1, wherein the replacing device further comprises an energy emitting device disposed above the lifting platform and configured to laminate powder layers of a workpiece on the working platform.

6. The replacing device for the laminated manufacturing platform according to claim 1, wherein the replacing device further comprises a locking device disposed on the base located between the two slide rails and configured to fix the base located between the two slide rails.

7. The replacing device for the laminated manufacturing platform according to claim 1, wherein the hollow frame is disposed at a peripheral edge of an upper surface of the base located between the two slide rails.

8. The replacing device for the laminated manufacturing platform according to claim 1, wherein the hollow frame is made of a metal.

9. The replacing device for the laminated manufacturing platform according to claim 1, wherein a diameter of the lifting platform is equal to an inner diameter of the opening.

10. The replacing device for the laminated manufacturing platform according to claim 1, wherein the sliding components are rolling wheels.
